(19) United States
(12) Patent Application Publication
(10) Pub. No.: US 2025/0217449 A1
(43) Pub. Date: Jul. 3, 2025

(54) CLASSIFICATION METHOD, CLASSIFICATION DEVICE, AND CLASSIFICATION SYSTEM

(71) Applicant: Panasonic Intellectual Property Management Co., Ltd., Osaka (JP)

(72) Inventors: Kei TASAKA, Osaka (JP); Suguru Nakao, Hyogo (JP); Yuki Iwamoto, Osaka (JP); Hiroshi Kunimoto, Osaka (JP); Takeshi Ueda, Osaka (JP)

(21) Appl. No.: 19/085,629

(22) Filed: Mar. 20, 2025

Related U.S. Application Data
(63) Continuation of application No. PCT/JP2023/030175, filed on Aug. 22, 2023.

(30) Foreign Application Priority Data
Sep. 22, 2022 (JP) 2022-151411

(51) Int. Cl. G06F 18/2413

(52) U.S. Cl. CPC G06F 18/2413

(57) ABSTRACT

A classification method includes calculating a plurality of pieces of reference calculation data from a plurality of pieces of data belonging to a second classification by using a machine learning model that has learned learning data including a plurality of pieces of data belonging to a first classification, calculating classification calculation data from one piece of acquisition data by using the machine learning model, and comparing data based on the plurality of pieces of reference calculation data with the classification calculation data to classify whether the one piece of acquisition data belongs to the second classification. The plurality of pieces of data belonging to the first classification, the plurality of pieces of data belonging to the second classification, and the one piece of acquisition data have a statistical deviation, and the second classification is different from a classification of the plurality of pieces of data included in the learning data.

### BACKGROUND

### 1. Technical Field

The present disclosure relates to a classification method, a classification device, and a classification system using a machine learning model.

### 2. Description of the Related Art

In recent years, a method using machine learning in processing such as inspection and identification of an object is known. In such a method, processing is executed by using a trained model that has learned data acquired from a sensor or the like.

For example, Patent Literature (PTL) 1 discloses a method for performing failure prediction by using a trained model that has learned data acquired from a sensor provided in a machine facility.
PTL 1: Unexamined Japanese Patent Publication No. 2018-147443

### SUMMARY

An object of the present disclosure is to provide a classification method, a classification device, and a classification system capable of reusing a trained model.

The present disclosure provides a classification method including calculating a plurality of pieces of reference calculation data from a plurality of pieces of data belonging to a second classification by using a machine learning model that has learned learning data including a plurality of pieces of data belonging to a first classification, calculating classification calculation data from one piece of acquisition data by using the machine learning model, and comparing data based on the plurality of pieces of reference calculation data with the classification calculation data to classify whether or not the one piece of acquisition data belongs to the second classification. The plurality of pieces of data belonging to the first classification, the plurality of pieces of data belonging to the second classification, and the one piece of acquisition data are pieces of data having a statistical deviation, and the second classification is a classification different from a classification to which the plurality of pieces of data included in the learning data belong.

The present disclosure provides a classification device including a processor, and a storage device having an instruction executable by the processor. The instruction configured to calculate a plurality of pieces of reference calculation data from a plurality of pieces of data belonging to a second classification by using a machine learning model that has learned learning data including a plurality of pieces of data belonging to a first classification, calculate classification calculation data from one piece of acquisition data by using the machine learning model, and compare data based on the plurality of pieces of reference calculation data with the classification calculation data to classify whether or not the one piece of acquisition data belongs to the second classification. The plurality of pieces of data belonging to the first classification, the plurality of pieces of data belonging to the second classification, and the one piece of acquisition data are pieces of data having a statistical deviation, and the second classification is a classification different from a classification to which the plurality of pieces of data included in the learning data belong.

The present disclosure provides a classification system including a sensor that acquires one piece of acquisition data, a classification device, and a notification device that notifies a user of a classification result of the classification device. The classification device is configured to calculate a plurality of pieces of reference calculation data from a plurality of pieces of data belonging to a second classification by using a machine learning model that has learned learning data including a plurality of pieces of data belonging to a first classification, calculate classification calculation data from one piece of acquisition data acquired by the sensor by using the machine learning model, and compare data based on the plurality of pieces of reference calculation data with the classification calculation data to output a result of classifying whether or not the one piece of acquisition data belongs to the second classification to the notification device. The plurality of pieces of data belonging to the first classification, the plurality of pieces of data belonging to the second classification, and the one piece of acquisition data are pieces of data having a statistical deviation, and the second classification is a classification different from a classification to which the plurality of pieces of data included in the learning data belong.

According to the present disclosure, the trained model can be reused.

### BRIEF DESCRIPTION OF THE DRAWINGS

FIG. 1 is a schematic block diagram illustrating an example of a classification system according to a first exemplary embodiment.

FIG. 2 is a schematic block diagram illustrating an example of a classification method according to the first exemplary embodiment.

FIG. 3 is a flowchart for explaining a procedure for creating numerical interval data according to the first exemplary embodiment.

FIG. 4 is a diagram illustrating a histogram of a reference calculation data group according to the first exemplary embodiment.

FIG. 5 is a graph representing an example of a vibration waveform generated when a first connector according to the first exemplary embodiment is fitted and first output data.

FIG. 6 is a graph representing an example of a vibration waveform generated when a second connector according to the first exemplary embodiment is fitted and second output data.

FIG. 7 is a flowchart for explaining processing in an operation phase according to the first exemplary embodiment.

FIG. 8 is a diagram illustrating a histogram of a reference calculation data group according to a second exemplary embodiment.

FIG. 9 is a graph representing an example of a vibration waveform acquired by a first sensor according to the second exemplary embodiment.

FIG. 10 is a graph representing an example of a vibration waveform acquired by a second sensor according to the second exemplary embodiment.

FIG. 11 is a flowchart for explaining determination processing according to the second exemplary embodiment.

FIG. 12 is a block diagram illustrating an example of a classification system according to a third exemplary embodiment.

FIG. 13 is an outer appearance perspective view for explaining an operation example of a toggle switch by a hand of a robot according to the third exemplary embodiment.

FIG. 14 is an outer appearance perspective view for explaining an operation example of a push switch by the hand of the robot according to the third exemplary embodiment.

FIG. 15 is a diagram illustrating a histogram of a reference calculation data group according to the third exemplary embodiment.

FIG. 16 is a diagram illustrating an example of a vibration waveform generated when a toggle switch according to the third exemplary embodiment is correctly operated.

FIG. 17 is a diagram illustrating an example of a vibration waveform generated when a push switch according to the third exemplary embodiment is correctly operated.

FIG. 18 is a diagram illustrating an example of a reliability evaluation method according to another exemplary embodiment.

### DETAILED DESCRIPTIONS

Exemplary embodiments will be described in detail below with reference to the drawings as appropriate. Note that unnecessarily detailed description is omitted in some cases. For example, detailed descriptions of already well-known matters and duplicated description of substantially identical configurations are not described in some cases. These omissions are intended to avoid excessive redundancy in the following description, and to facilitate understanding of those skilled in the art. Note that the accompanying drawings and the following description are provided for those skilled in the art to fully understand the present disclosure, and are not intended to limit the subject matter recited in the appended claims.

### Background of Invention

In a method using machine learning in the related art, tasks such as inspection and identification of an object are executed by acquiring data from a sensor or the like installed in a target object, training a large amount of acquired data as learning data by a machine learning model, and creating and using a trained model. For example, PTL 1 discloses a method for predicting a failure of a mechanical facility that is a target object from data acquired from an installed sensor by using an auto encoder that is one of methods of machine learning. As described above, in the method using the machine learning, it is possible to determine an abnormality of the mechanical facility from the data acquired from the sensor, and it is possible to determine which one state of the plurality of states corresponds to in a case where there are a plurality of states other than normal and abnormal states of the mechanical facility.

However, for example, in a case where a change occurs in the target object from which the data is acquired, such as in a case where the mechanical facility is replaced, or in a case where a change occurs in a measurement system, such as in a case where the sensor or the like installed in the mechanical facility is replaced, the acquired data also changes. Thus, when the mechanical facility or the sensor is replaced, it is necessary to newly create a trained model that has learned data acquired after the mechanical facility or the sensor is replaced.

In order to solve the above problem, the inventors of the present invention have found that, in a trained model using, as learning data, data acquired before the machine facility or the sensor is replaced, when data different from the learning data such as the data acquired after the machine facility or the sensor is replaced is input, a statistical deviation different from calculation data calculated when the learning data is input occurs in calculation data calculated as an input and output error of the trained model. The statistical deviation occurring in the calculation data when data different from such learning data is input to the trained model is stored in advance and is used for determination. As a result, even in a case where there is a change in the acquired data, it is possible to reuse the trained model using data acquired before the change occurs as the learning data. Here, the “reuse” of the trained model in the present exemplary embodiment means that the trained model that has learned data belonging to a predetermined classification is used to classify data belonging to a classification different from the predetermined classification.

### First Exemplary Embodiment

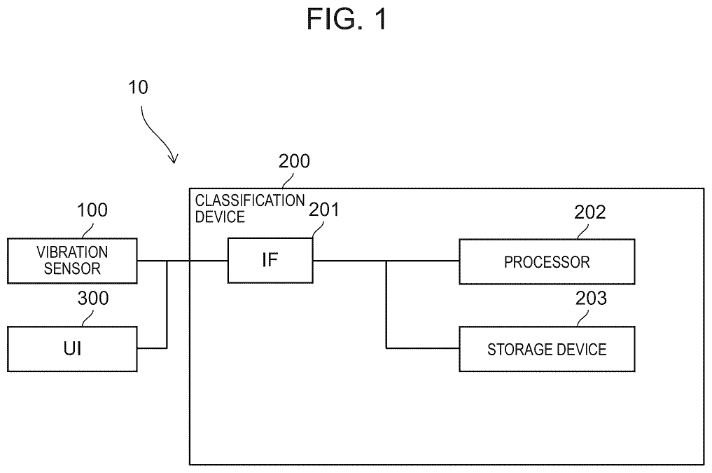

Hereinafter, a first exemplary embodiment will be described with reference to FIGS. 1 to 7. In a classification method, a classification device, and a classification system according to the first exemplary embodiment, a target object to be classified is a connector having a pair of mechanisms used to connect articles. In the first exemplary embodiment, a case where a fitting state of the connector is determined will be described as an example.

### [Configuration of Classification System]

FIG. 1 is a schematic block diagram illustrating an example of the classification system according to the first exemplary embodiment. As illustrated in FIG. 1, classification system 10 includes vibration sensor 100 that acquires vibration of a target object, classification device 200 that determines the target object based on the acquired vibration, and user interface (UI) 300 for outputting a determination result.

Classification system 10 according to the first exemplary embodiment is a system that determines a fitting state of connectors. “Fitting” means that a pair of mechanical components is fixed at least in physical contact. In the present exemplary embodiment, fitting of the connectors will be described as an example of the fitting. The “connectors” are a pair of mechanisms used to connect articles, and are, for example, a male connector and a female connector. As an example, the connectors are used to physically and/or electrically connect devices mounted on an automobile or the like. In addition, the connector includes a connection portion using a latch mechanism.

Hereinafter, a configuration of classification system 10 will be described.

Vibration sensor 100 is a sensor for detecting vibration generated when the connectors are fitted and acquiring the vibration as vibration information. Vibration sensor 100 may include, for example, a piezoelectric element using a piezoelectric effect in which a voltage is generated when a pressure is applied.

For example, vibration sensor 100 is attached to a working glove worn by a user. Specifically, vibration sensor 100 is attached to a thumb portion of the working glove. Note that an attachment place of vibration sensor 100 is not limited to the thumb portion of the working glove. Vibration sensor 100 detects vibration data (voltage) in response to the vibration generated when the user wearing the working glove grips and fits the connectors. In addition, the vibration data detected by vibration sensor 100 is acquired by classification device 200.

Classification device 200 is a device that determines the fitting state based on the vibration information acquired from vibration sensor 100. Classification device 200 includes interface (IF) 201, processor 202, and storage device 203.

IF 201 connects vibration sensor 100 and classification device 200 to be configured to communicate with each other. For example, in a case where vibration sensor 100 or UI 300 is a universal serial bus (USB) device, IF 201 is a USB port. Note that IF 201 may be any device that can connect classification device 200 and vibration sensor 100 or UI 300 to be configured to communicate with each other, and is not limited thereto.

Processor 202 reads and executes a computer-executable instruction stored in storage device 203 to be described later. Processor 202 is constructed by using, for example, a central processing unit (CPU), a micro processing unit (MPU), a graphics processing unit (GPU), or a field-programmable gate array (FPGA). Note that processor 202 may be any other processing unit that can execute a computer-executable instruction, and is not limited thereto.

Storage device 203 is a storage medium that stores programs and data necessary to realize functions of classification device 200. For example, storage device 203 can be realized by, for example, a hard disk drive (HDD), a solid state drive (SSD), a random access memory (RAM), a dynamic random access memory (DRAM), a ferroelectric memory, a flash memory, a magnetic disk, or a combination thereof.

UI 300 is a device that comes in contact with the user when the user and classification device 200 exchange information, such as receiving an operation from the user and outputting a processing result from classification device 200. For example, the UI includes a touch display or the like. In addition, in UI 300, a device that receives the operation from the user and a device that outputs the processing result, such as a mouse, a keyboard, and a display, may be separate. Note that UI 300 may be only a device that notifies the user of the processing result of classification device 200, and may include a display, a buzzer, a light emitting diode (LED), or the like.

### [Operation of Classification System]

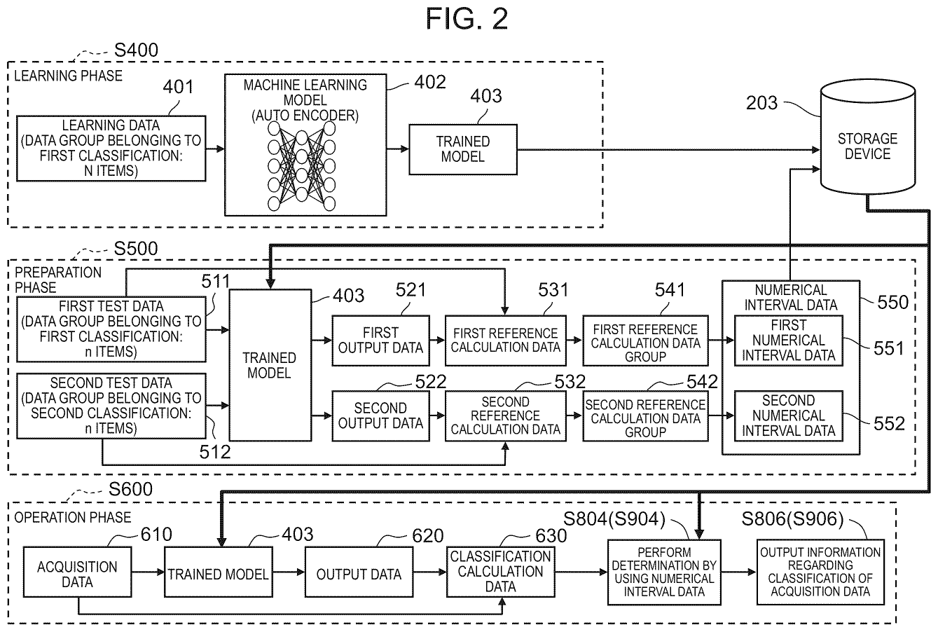

An operation of classification system 10 according to the first exemplary embodiment will be described below with reference to FIG. 2 to FIG. 7. Classification system 10 according to the first exemplary embodiment determines whether or not fitting of a first connector or a second connector is normally performed by using a trained model that has learned a vibration waveform of the first connector, and outputs a determination result. Note that the first connector and the second connector are two types of connectors having different shapes or the like.

FIG. 2 is a schematic block diagram illustrating an example of the classification method according to the first exemplary embodiment. The classification method is divided into three phases: “learning phase S400” in which a trained model is created; “preparation phase S500” in which numerical interval data suitable for each connector is calculated by using the trained model created in learning phase S400; and “operation phase S600” in which determination is performed on acquisition data to be classified by using the trained model created in learning phase S400 and the numerical interval data created in preparation phase S500.

Each phase will be described in detail below.

In the description of the present exemplary embodiment, “learning” refers to creating a “trained model” by performing learning by using learning data and any learning algorithm. The trained model is updated in a timely manner as learning proceeds by using a plurality of pieces of learning data, and an output thereof changes even with the same input. Thus, here, a model used in learning is described as a “machine learning model”, and a machine learning model subjected to learning to a certain extent is described as a “trained model”. In addition, here, data used in learning is described as “learning data”, and data used to determine numerical interval data to be described later is described as “test data”.

### [Learning Phase]

In learning phase S400 in FIG. 2, processor 202 creates trained model 403 by using N pieces of data belonging to a first classification as learning data 401 for training of machine learning model 402. Processor 202 stores created trained model 403 in storage device 203. In the present exemplary embodiment, an auto encoder based on a neural network is used as a learning algorithm of machine learning model 402. Note that the auto encoder may be implemented by using a known method, and a detailed description thereof will be omitted here.

In the first exemplary embodiment, the data belonging to the first classification used as learning data 401 is a vibration waveform (time domain) of the first connector at the time of normal fitting acquired by vibration sensor 100. Even though the first connector is normally fitted, since the vibration waveform of the first connector is influenced by, for example, a state of a working glove or the like to which vibration sensor 100 is attached, a position to which vibration sensor 100 is attached, a worker who performs fitting, an environment such as a method of holding the connectors, or the like, the vibration waveform is slightly different for each fitting. In addition, the vibration waveform of the first connector is slightly different due to manufacturing variations even in the same type of connectors. Trained model 403 in learning phase S400 uses, as the learning data, the vibration waveform of the first connector slightly different for each fitting to learn a feature in the vibration waveform of the first connector regardless of the influence of the manufacturing variation, environment, or the like.

Here, a method called the auto encoder used in the present exemplary embodiment is a machine learning model including an encoder portion that extracts a feature of an input vibration waveform and a decoder portion that reconstructs a vibration waveform from the extracted feature. In this machine learning model, learning is performed such that the input vibration waveform and the output waveform output from the decoder portion are close to each other.

In trained model 403 that has learned the vibration waveform of the first connector, a feature common to the vibration waveform of the first connector at the time of normal fitting is extracted from the input vibration waveform in the encoder portion, and an element other than the common feature is removed. Then, in the decoder portion, the vibration waveform is reconstructed from the feature extracted in the encoder portion.

Thus, in a case where a vibration waveform having the feature common to the vibration waveform of the first connector at the time of normal fitting is input in trained model 403, since the number of elements to be removed is small, the output vibration waveform has a small deviation from the input vibration waveform. On the other hand, in trained model 403, in a case where a vibration waveform not related to the vibration waveform of the first connector at the time of normal fitting is input, since a feature of the input vibration waveform is not common to the vibration waveform of the first connector at the time of normal fitting and the number of elements to be removed in the encoder portion is large, the output vibration waveform has a large deviation from the input vibration waveform.

### [Preparation Phase]

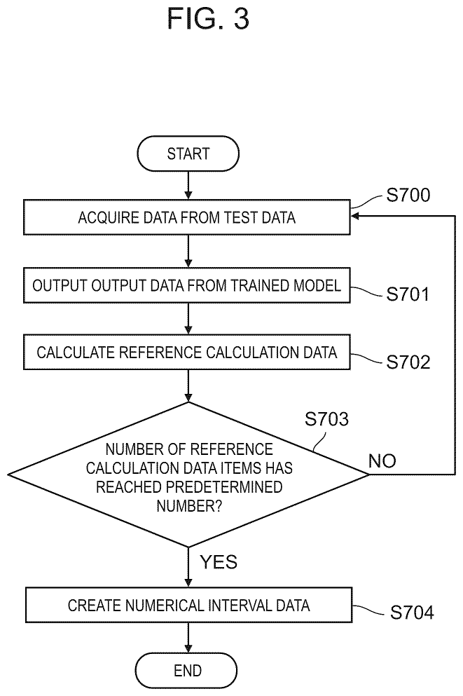

Hereinafter, preparation phase S500 will be described with reference to FIGS. 2 and 3.

In preparation phase S500 in FIG. 2, processor 202 creates numerical interval data 550 to be used in operation phase S600 to be described later from the test data by using trained model 403 created in learning phase S400. In the first exemplary embodiment, the test data is first test data 511 including vibration waveforms (pieces of data belonging to the first classification) when n-numbered first connectors are normally fitted, and second test data 512 including vibration waveforms (pieces of data belonging to a second classification) when n-numbered second connectors are normally fitted. In addition, numerical interval data 550 is first numerical interval data 551 generated by first test data 511 and second numerical interval data 552 generated by second test data 512.

FIG. 3 is a flowchart illustrating a procedure for creating numerical interval data 550 according to the first exemplary embodiment. Hereinafter, a creation procedure of first numerical interval data 551 will be described.

First, processor 202 acquires one vibration waveform of the first connector from first test data 511 (S700).

Subsequently, processor 202 performs a numerical operation by using, as an input, trained model 403 using the vibration waveform of the first connector acquired in step S700 to obtain first output data 521 (S701).

Subsequently, processor 202 calculates first reference calculation data 531 by performing comparison processing between the vibration waveform of the first connector acquired in step S700 and first output data 521 obtained in step S701 (S702). In the present exemplary embodiment, first reference calculation data 531 is an error (difference) between the vibration waveform of the first connector, which is the input of trained model 403, and first output data 521. More specifically, the first reference calculation data is a sum or an average of errors, and may be calculated by using, for example, a known mean squared error (MSE), a root mean squared error (RMSE), a mean absolute error (MAE), or the like.

Subsequently, processor 202 determines whether or not the number of pieces of first reference calculation data 531 calculated from first test data 511 reaches a predetermined number set in advance (S703). In a case where the calculated number of pieces of first reference calculation data 531 is less than the predetermined number (NO in S703), the procedure is executed again from step S700. As described above, processor 202 calculates first reference calculation data group 541 including the plurality of pieces of first reference calculation data 531 by repeating the procedure of steps S700 to S702. In the first exemplary embodiment, it is determined whether or not the calculated number of pieces of first reference calculation data 531 reaches n. In addition, in a case where the number of pieces of first reference calculation data 531 reaches the predetermined number (YES in S703), the processing of processor 202 proceeds to step S704.

Finally, processor 202 creates first numerical interval data 551 by using first reference calculation data group 541 calculated in step S703 (S704). First numerical interval data 551 is data related to a numerical interval obtained by a statistical deviation of first reference calculation data group 541. Details of first numerical interval data 551 will be described later.

In steps S700 to S704, the creation procedure for first numerical interval data 551 has been described. Since second numerical interval data 552 in FIG. 2 is created in a creation procedure similar to steps S701 to S704, although not described in detail, second numerical interval data 552 is created by using second test data 512 instead of first test data 511. In addition, in step S701, processor 202 outputs second output data 522 instead of first output data 521, and in step S702, processor 202 calculates pieces of second reference calculation data 532 instead of pieces of first reference calculation data 531. In addition, in step S703, processor 202 calculates second numerical interval data 552 from second reference calculation data group 542.

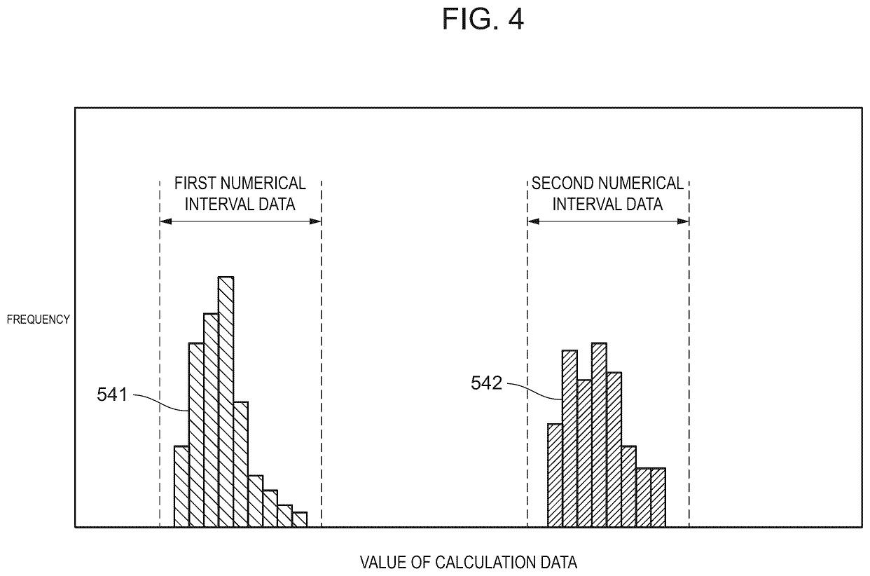

Hereinafter, a difference between first numerical interval data 551 and second numerical interval data 552 will be described with reference to FIGS. 4 to 6.

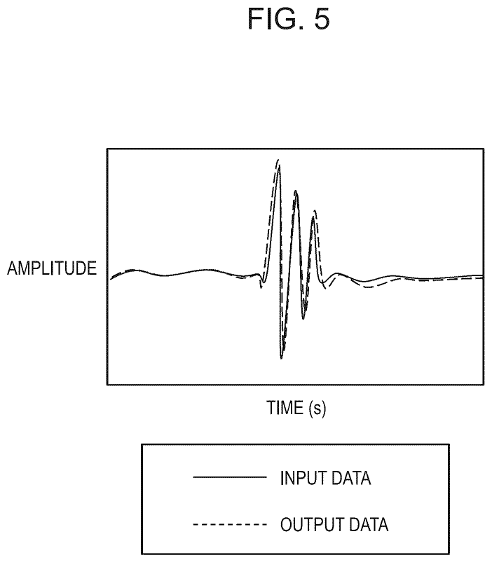

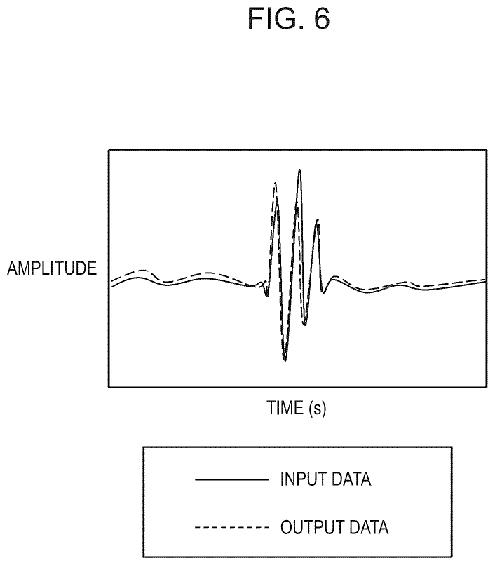

FIG. 4 is a diagram illustrating a histogram of the reference calculation data group according to the first exemplary embodiment. In FIG. 4, a horizontal axis represents a value of the calculation data (input and output error in trained model 403), and a vertical axis represents a frequency. In addition, FIGS. 5 and 6 are diagrams illustrating vibration waveforms (time domain) generated when the two types of connectors according to the first exemplary embodiment are correctly fitted, and output data in a case where each vibration waveform is input to trained model 403. FIG. 5 is an example of the vibration waveform generated when the first connector according to the first exemplary embodiment is fitted and first output data 521 output by the fitting. FIG. 6 is an example of the vibration waveform generated when the second connector according to the first exemplary embodiment is fitted and second output data 522 output by the fitting.

Trained model 403 extracts elements corresponding to the feature of the vibration waveform of the first connector at the time of normal fitting from the input vibration waveform, and outputs, as output data, the vibration waveform reconstructed based on the extracted feature. Thus, in a case where the vibration waveform of the first connector at the time of normal fitting is input to trained model 403, there is almost no element to be removed from the input data, and there is almost no difference (error or difference) between the input data and the output data as illustrated in FIG. 5. Accordingly, in FIG. 4, in first reference calculation data 531 calculated as an input and output error (difference) of trained model 403 when the vibration waveform of the first connector is input, first reference calculation data group 541 that is a set thereof also shows a statistical deviation to a small value as an error.

On the other hand, in FIG. 4, second reference calculation data group 542 calculated by trained model 403 using the vibration waveform of the second connector as an input shows a statistical deviation to a large value as an error as compared with first reference calculation data group 541. The reason why the statistical deviation occurs in the large value in second reference calculation data group 542 compared with first reference calculation data group 541 will be described below.

First, the reason why the statistical deviation occurs in first reference calculation data group 541 and second reference calculation data group 542 will be described. Here, the “statistical deviation” is a tendency that is commonly seen in a plurality of pieces of acquired data when a predetermined trial is repeated and data related to the trial is acquired multiple times.

As described above, first reference calculation data 531 is data calculated by using the vibration waveform generated when the first connector is normally fitted as input data of trained model 403. The first connector has a structure common to the connectors called a latch structure as a source of vibration, and the vibration waveform of the connector at the time of normal fitting is caused by a single vibration of the latch structure, which is a structure common to such connectors, like a cantilever. Thus, even though the vibration waveform of the first connector at the time of normal fitting is acquired multiple times, there is a variation in the vibration waveform due to the influence of the environment or the like at the time of fitting, but a feature or the like due to the latch structure is found in any vibration waveform acquired multiple times. That is, the vibration waveform of the first connector has a statistical deviation.

As described above, the vibration waveform of the first connector at the time of normal fitting used for the input data of trained model 403 has a statistical deviation. Here, the output data output from trained model 403 from such input data is obtained by extracting and reconstructing the feature or the like due to the latch structure. Thus, the output data of trained model 403 also has a statistical deviation. That is, the input data and the output data of trained model 403 are pieces of data having a statistical deviation. First reference calculation data 531 is calculated as an error between the input data and the output data having such a statistical deviation, and the error calculated in this manner is distributed in a predetermined numerical interval. Thus, a statistical deviation also occurs in first reference calculation data group 541. In addition, similarly to the first connector, since the second connector also has the latch structure, the vibration waveform of the second connector also has a statistical deviation, and the statistical deviation also occurs in second reference calculation data group 542.

Next, the reason why the statistical deviation occurs in the large value in second reference calculation data group 542 compared to first reference calculation data group 541 will be described.

First, the connectors have different shapes depending on the types, such as the first connector and the second connector. The vibration waveform of the connector at the time of fitting is caused by the latch structure which is a structure common to the connectors as described above, but is also influenced by a different shape for each type of the connectors. Thus, the feature of the vibration waveform of the connector at the time of fitting includes two features of features of different shapes or the like for each type of the connectors in addition to the feature due to the latch structure which is the structure common to such connectors. For example, the vibration waveforms of the first connector and the second connector at the time of normal fitting show vibration waveforms illustrated in FIGS. 5 and 6, and positions of peaks in the vibration waveforms are different due to a difference in features due to different shapes or the like for each type of connectors.

Here, since trained model 403 learns the vibration waveform of the first connector, in a case where any vibration waveform is input to trained model 403, a feature due to the latch structure and a feature due to the shape or the like of the first connector are extracted from the input data, and the extracted features are output as output data.

In a case where the vibration waveform of the second connector is input to trained model 403, the input data includes the feature due to the latch structure common to the connectors. Thus, in the output data, the feature due to the latch structure is extracted as an element corresponding to the feature of the vibration waveform of the first connector. However, since the vibration waveform of the first connector and the second connector are different in features due to the shapes or the like of the connectors, such a feature due to the shape or the like of the second connector is not extracted in the output data. Thus, as illustrated in FIG. 6, a difference in the features due to the shapes or the like of the connectors appears in the difference between the input data and the output data as a difference in the peak positions of the vibration waveforms. Such a difference in features due to the shapes or the like of the connectors of the vibration waveforms of the first connector and the second connector is reflected in second reference calculation data 532 which is the input and output error of trained model 403. As a result, second reference calculation data group 542 is distributed at a position having a larger value than first reference calculation data group 541 as illustrated in FIG. 4.

Accordingly, as compared with first reference calculation data group 541, second reference calculation data group 542 shows the statistical deviation to the large value.

As described above, not only first reference calculation data group 541 but also second reference calculation data group 542 has a statistical deviation. Numerical interval data 550 is a numerical interval based on such a statistical deviation of the reference calculation data group. Specifically, numerical interval data 550 is calculated from an average value and standard deviation a of the reference calculation data group. In the first exemplary embodiment, first numerical interval data 551 is calculated as an interval of the average value ±3σ of first reference calculation data group 541, and second numerical interval data 552 is calculated as an interval of the average value ±3σ of second reference calculation data group 542. Note that the calculated numerical interval may be an interval of the average value ±2a of the reference calculation data group or an interval calculated by another numerical operation. First numerical interval data 551 and second numerical interval data 552 are recorded in storage device 203, as a boundary value of the calculated interval or the average value and a value of standard deviation a.

### [Operation Phase]

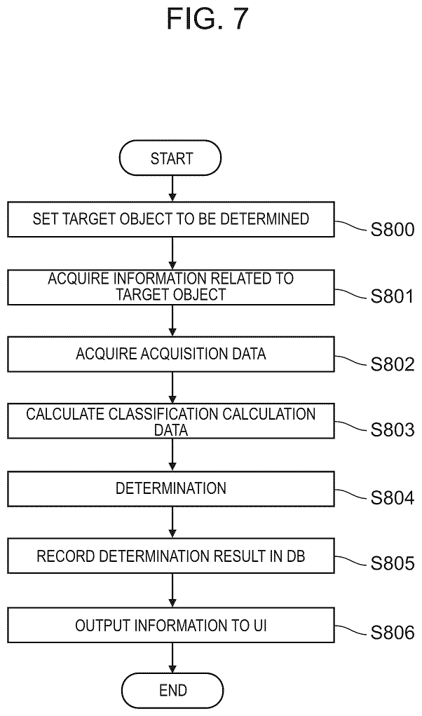

Hereinafter, operation phase S600 will be described with reference to FIGS. 2 and 7.

In operation phase S600 in FIG. 2, processor 202 calculates classification calculation data 630 for acquisition data 610 to be classified described later by using trained model 403 created in learning phase S400. Further, processor 202 performs determination processing (S804) to be described later on classification calculation data 630 by using numerical interval data 550 created in preparation phase S500, and outputs information regarding the classification of acquisition data 610 based on the result.

FIG. 7 is a flowchart for explaining processing in operation phase S600 according to the first exemplary embodiment. In the operation phase of the first exemplary embodiment, classification device 200 can perform three patterns of operations by classifying acquisition data 610 to be classified. A first pattern of the three patterns is a case where it is determined whether or not the fitting of the second connector is normal. A second pattern is a case where it is determined whether or not the fitting of the first connector is normal. A third pattern is a case where it is determined which connector is fitted. First, an implementation procedure in the case where it is determined whether or not the fitting of the second connector, which is the first operation pattern, will be described.

First, processor 202 sets a target object from which acquisition data 610 to be classified is acquired (S800). Here, in order to determine the fitting of the second connector, the second connector is set as the target object. Note that the setting of the target object may be set in advance. In addition, the setting may be performed by selection of the user by using UI 300.

Subsequently, processor 202 acquires information related to the second connector corresponding to the target object set in step S800 from storage device 203 (S801). Specifically, processor 202 acquires at least second numerical interval data 552 as the information related to the second connector.

Subsequently, the user performs a fitting work of the second connector corresponding to the target object set in step S800. Processor 202 acquires acquisition data 610 that is the vibration waveform of the second connector at the time of fitting via vibration sensor 100 (S802).

Subsequently, processor 202 inputs acquisition data 610 acquired in step S802 to trained model 403 to create output data 620, and calculates classification calculation data 630 by comparison processing between acquisition data 610 and created output data 620 (S803). This processing is processing similar to steps S701 and S702 described in preparation phase S500.

Subsequently, processor 202 determines whether or not the second connector is correctly fitted by using classification calculation data 630 calculated in step S803 and second numerical interval data 552 acquired in step S801 (S804). Specifically, it is determined whether or not a value of classification calculation data 630 is included in a numerical interval indicated by second numerical interval data 552. Here, in a case where the fitting of the second connector is normally performed, acquisition data 610 has a statistical deviation similar to the case of the vibration waveform of the second connector at the time of fitting acquired in preparation phase S500. Classification calculation data 630 is calculated from the vibration waveform acquired when the second connector is normally fitted by processing similar to second reference calculation data 532 in preparation phase S500. Thus, the value of classification calculation data 630 is considered to be included in a numerical interval indicated by the statistical deviation of second reference calculation data group 542 (the numerical interval indicated by second numerical interval data 552). Accordingly, processor 202 can determine that the fitting is normal in a case where classification calculation data 630 is included in the numerical interval.

Subsequently, processor 202 records the determination result of step S804 in a database (DB) such as storage device 203 (S805). Note that the information to be recorded may include information such as connector information, work date and time, and user name.

Finally, processor 202 outputs information regarding the classification of acquisition data 610 to UI 300 such as a display (S806). Specifically, processor 202 outputs information indicating whether or not the fitting of the second connector is normally performed as the determination result of step S804.

Here, the “information regarding the classification” of acquisition data 610 is information indicating to which classification acquisition data 610 belongs. The determination result of step S804 is a result of classifying whether or not acquisition data 610 is the vibration waveform of the second connector acquired at the time of normal fitting, which is the “data belonging to the second classification”, and indicates the information regarding the classification of acquisition data 610.

Accordingly, in operation phase S600, classification device 200 can notify the user of whether or not the fitting of the second connector is normally performed.

As described above, in the first operation pattern, classification device 200 can determine the fitting of the second connector by using trained model 403 that has learned the vibration waveform of the first connector at the time of normal fitting. In the related art, in a case where connectors mounted on products are different, the user needs to create a trained model that has learned vibration waveforms at the time of fitting for the connectors. However, as in classification device 200, in the trained model that has learned a vibration waveform of a predetermined connector at the time of fitting, a statistical deviation of calculation data calculated from a vibration waveform of a connector different from the predetermined connector at the time of fitting is recorded as the numerical interval data, and thus, the fitting determination of the connector different from the predetermined connector can be performed without creating the trained model again. That is, the learning model that has learned the data belonging to the predetermined classification can be reused for classifying whether or not the data belongs to a classification different from the predetermined classification.

Next, a case where classification device 200 determines whether or not the fitting of the first connector is normally performed as the second operation pattern, will be described. The second operation pattern is performed in a procedure similar to steps S800 to S806 in the first operation pattern. Thus, although not described in detail, the first connector is set as the target object instead of the second connector in step S800, and first numerical interval data 551 is used instead of second numerical interval data 552 in step S804. As a result, classification device 200 can determine whether or not the fitting of the first connector is normally performed. That is, classification device 200 can classify whether or not acquisition data 610 is the vibration waveform of the first connector acquired at the time of normal fitting, which is the “data belonging to the first classification”.

Finally, a case where classification device 200 determines which connector fitted when the acquired vibration waveform is generated as the third operation pattern, will be described.

In step S800, the target object to be set is different. Processor 202 sets the first connector and the second connector as the target objects to be determined.

In step S801, the information to be acquired is different. Processor 202 acquires first numerical interval data 551 that is information related to the first connector and second numerical interval data 552 that is information related to the second connector.

In step S804, the determination content is different. Processor 202 determines which connector fitted when acquisition data 610 is generated by using classification calculation data 630 calculated in step S803 and first numerical interval data 551 and second numerical interval data 552 acquired in step S801. Specifically, it is determined whether a value of the calculation data is included in a numerical interval indicated by first numerical interval data 551 or a numerical interval indicated by second numerical interval data 552. For example, processor 202 determines the fitting of the first connector in a case where classification calculation data 630 is included in first numerical interval data 551, and determines that there is no corresponding connector in a case where classification calculation data 630 is not included in any numerical interval.

In step S806, the information regarding the classification of acquisition data 610 output to UI 300 is different. Specifically, processor 202 outputs information indicating which connector is fitted as the determination result of step S804. In addition, when it is determined that there is not any fitted connector, processor 202 outputs information indicating that there is no corresponding connector. The determination result in step S804 is information regarding the classification of whether acquisition data 610 belongs to any classification such that acquisition data 610 is a vibration waveform (data belonging to the first classification) acquired when the first connector is normally fitted. Alternatively, the determination result of step S804 is information regarding the fact that acquisition data 610 does not belong to any classification such that acquisition data 610 is different from the vibration waveform of any connector. These pieces of information indicate information regarding the classification of acquisition data 610.

As described above, classification device 200 can notify the user which connector of the first connector or the second connector is normally fitted. Accordingly, the user can determine whether or not the first connector and the second connector are fitted to each other without switching the setting.

In the related art, in order to identify fitting of a plurality of connectors like the first connector and the second connector, it is necessary for the user to create a trained model that has learned the plurality of connectors. However, as in classification device 200, in a case where a trained model that has learned the vibration waveform of a predetermined connector at the time of fitting, it is possible to identify the fitting of the plurality of connectors by recording, as the numerical interval data, the statistical deviation of the calculation data calculated from the vibration waveform of each of the plurality of connectors at the time of fitting. That is, even in a case of classifying which of a plurality of classifications the acquisition data belongs to, it is possible to reuse the trained model that has learned the data belonging to the predetermined classification.

In addition, in the third operation pattern, first numerical interval data 551 and second numerical interval data 552 are created in preparation phase S500 and are used in operation phase S600, but third numerical interval data regarding a third connector different from the first connector and the second connector may be created instead of first numerical interval data 551 in preparation phase S500 and may be used in operation phase S600. In this case, the third numerical interval data may be created from a vibration waveform of the third connector at the time of fitting by using a model that has learned the vibration waveform of the first connector at the time of fitting, and the third numerical interval data may be used for the determination of operation phase S600.

As described above, in a case where the third numerical interval data is used instead of first numerical interval data 551, the first connector that is the target object for which trained model 403 has learned the vibration waveform is not included in the target object for which the fitting is determined in the determination for identifying which of the plurality of connectors is fitted. However, it is possible to identify the fitting of the plurality of connectors like the second connector and the third connector by using second numerical interval data 552 and the third numerical interval data. That is, the third numerical interval data is created from data belonging to a third classification different from the first classification and the second classification by using the model that has learned the data belonging to the first classification, and thus, the acquisition data can be classified even in a case where the classification to which classification does the acquisition data belongs for a plurality of classifications not including the first classification.

As described above, in the first exemplary embodiment, the operation of classification system 10 in a case where the classification to which the acquisition data belongs is a classification based on the type of the target object, such as the first connector and the second connector, has been described. In classification system 10, in a target object called a connector, the first connector and the second connector are two types of target objects having different shapes or the like. In addition, a normal vibration waveform of each connector is classified as one classification corresponding to a type of a target object called a connector. That is, as in the first exemplary embodiment, the numerical interval data corresponding to each classification is used, and thus, the trained model that has learned the data belonging to the predetermined classification such as the vibration waveform of the first connector at the time of fitting can also be reused in a case where data belonging to a classification different from the predetermined classification is classified, such as the vibration waveform of the second connector at the time of fitting.

In addition, in the case of the first exemplary embodiment, there are N pieces of learning data and n pieces of test data, but as in a case where N is 500 and n is 30, n may be less than or equal to 1/10 of N. In the related art, in order to classify whether or not data belongs to a classification different from the data of the predetermined classification used as the learning data, it is necessary to create a trained model again by using N pieces of learning data, which is larger than n pieces of learning data. This is because it is necessary to perform learning such that a common feature can be extracted from data having a plurality of values such as the vibration waveform when the trained model is created.

On the other hand, in a case where the numerical interval data is used as in classification device 200, the output data of the trained model is compared with the test data, and the calculation data indicated by the error between the output data and the test data is calculated as the comparison result, and a set thereof is used. In this case, as compared with a case where a feature in the entire vibration waveform is extracted from a large amount of data as in a case where a trained model is created again, since a degree of difference between pieces of data may be read from a set of errors between the output data and the test data, the number of pieces of test data required is small. Thus, when there are n pieces of test data, which is a very smaller number than N pieces of learning data, the numerical interval data can be obtained, and a classification device that can determine the data belonging to each classification can be created. That is, the trained model that has learned the data belonging to the predetermined classification is reused by using the numerical interval data in this manner, and thus, it is possible to reduce the number of data necessary for constructing a system for classifying data belonging to a classification different from the predetermined classification.

In addition, in creating the trained model as described above, when a feature is extracted from data having a plurality of values such as the vibration waveform, it is necessary to repeat one vibration waveform multiple times and perform an operation based on the machine learning model. On the other hand, when the numerical interval data is calculated, one comparison operation may be performed on one vibration waveform, and the calculation data may be calculated as a result. Thus, in a case where the numerical interval data is used as compared with a case where the trained model is created again, since the amount of calculation for one vibration waveform used for constructing the system may be small and the number of pieces of necessary data may be small as described above, the amount of calculation required for constructing the system can be reduced.

### Second Exemplary Embodiment

Next, a second exemplary embodiment will be described. In the first exemplary embodiment, the reuse of the trained model in a case where the target object for collecting data is different, such as when the connector mounted on the product is changed, has been described. On the other hand, in the second exemplary embodiment, reuse of a trained model in a case where sensors that acquire data for the same target object are different will be described. Note that description of details overlapping with the first exemplary embodiment will be omitted, and description will be given focusing on the difference.

A first sensor and a second sensor are two sensors having different shapes or the like, and may be, for example, two vibration sensors including piezoelectric elements having different radii, two vibration sensors manufactured by different manufacturers, a vibration sensor capable of acquiring vibration by sound such as a vibration sensor and a microphone, or the like. In the following exemplary embodiment, two vibration sensors including piezoelectric elements having different radii will be described as an example.

### [Configuration of Classification System]

A classification system according to the second exemplary embodiment will be described hereinafter. In the classification system according to the second exemplary embodiment, a difference from the classification system according to the first exemplary embodiment illustrated in FIG. 1 is that there are a plurality of vibration sensors 100. In the second exemplary embodiment, a case where two vibration sensors such as the first sensor and the second sensor are used as vibration sensors 100 will be described. Note that the number of vibration sensors 100 is not limited to two, and may be three or more. Configurations other than the above configuration are similar to the configurations of classification system 10 according to the first exemplary embodiment.

### [Operation of Classification System]

Hereinafter, an operation of the classification system according to the second exemplary embodiment will be described. Classification system 10 according to the first exemplary embodiment determines whether or not the fitting of the connectors is normally performed in a case where the vibration waveforms of different types of connectors at the time of fitting are acquired by using sensors having the same shape or the like. On the other hand, in the classification system according to the second exemplary embodiment, in a case where a vibration waveform of one type of connector at the time of fitting is acquired by using sensors having different shapes or the like such as the first sensor and the second sensor, it is determined whether or not fitting is normally performed.

In a classification method according to the second exemplary embodiment, a difference from the classification method according to the first exemplary embodiment is that vibration waveforms of one type of connector acquired by different sensors are used as pieces of test data, and a processing procedure is similar. Thus, the classification method according to the second exemplary embodiment will be described below with reference to FIG. 2.

In FIG. 2, in the case of the classification method according to the second exemplary embodiment, a trained model that has learned data of the first sensor is created in “learning phase S400”, numerical interval data suitable for each sensor is calculated by using the trained model created in learning phase S400 in “preparation phase S500”, and determination is made on unknown data by using the trained model created in learning phase S400 and the numerical interval data created in preparation phase S500 in “operation phase S600”. Hereinafter, description of contents overlapping with the first exemplary embodiment will be omitted, and each phase will be described in detail focusing on a difference.

### [Learning Phase]

In the second exemplary embodiment, the data belonging to the first classification used as learning data 401 is the vibration waveform (time domain waveform) of the first connector at the time of normal fitting acquired by the first sensor. Thus, in trained model 403 created in learning phase S400, a feature common to the vibration waveform of the first connector at the time of normal fitting acquired by the first sensor is extracted from the input vibration waveform in the encoder portion, and elements other than the common feature are removed. Then, in the decoder portion, the vibration waveform is reconstructed from the feature extracted in the encoder portion. Even though the first connector is normally fitted, since the vibration waveform of the first connector is influenced by, for example, a state of a working glove or the like to which the first vibration sensor is attached, a position to which the first vibration sensor is attached, an environment such as a method of a worker who performs fitting, or the like, the vibration waveform of the first connector is slightly different for each fitting. In addition, the vibration waveform of the first connector is slightly different due to manufacturing variations even in the same type of connectors. Trained model 403 in learning phase S400 uses, as the learning data, the vibration waveform of the first connector acquired by the first sensor slightly different for each fitting to learn a feature common to the vibration waveform of the first connector acquired by the first sensor that is not influenced by a manufacturing variation, environment, or the like.

### [Preparation Phase]

In the second exemplary embodiment, first test data 511 is a set of vibration waveforms (data belonging to the first classification) of the first connector acquired by the first sensor, and second test data 512 is a set of vibration waveforms (data belonging to the second classification) of the first connector acquired by the second sensor.

In addition, numerical interval data 550 is first numerical interval data 551 created by first test data 511 and second numerical interval data 552 created by the second test data. A method for calculating first numerical interval data 551 and second numerical interval data 552 is similar to the method in the first exemplary embodiment, and first numerical interval data 551 and second numerical interval data 552 are created in a creation procedure similar to steps S701 to S704, and thus, the details thereof are omitted.

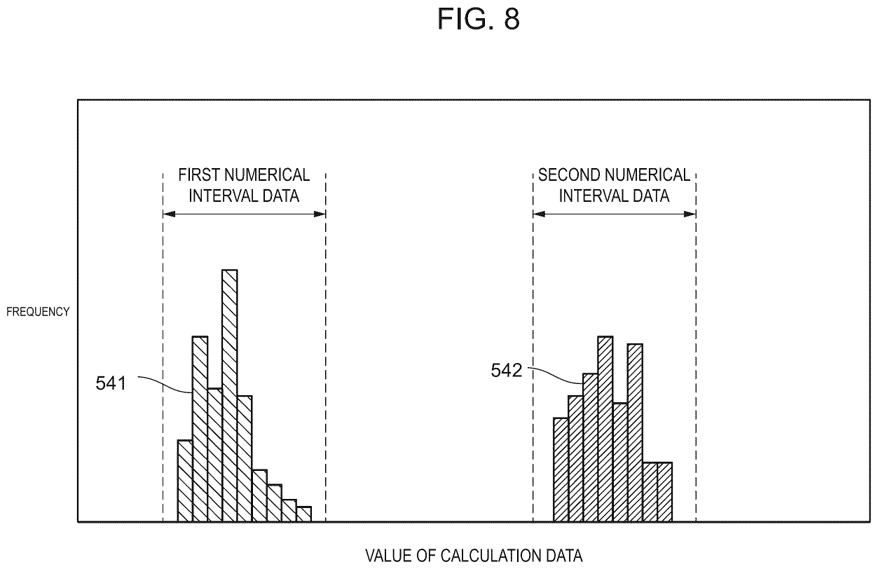

A difference between first numerical interval data 551 and second numerical interval data 552 in the second exemplary embodiment will be described below with reference to FIGS. 8 to 10.

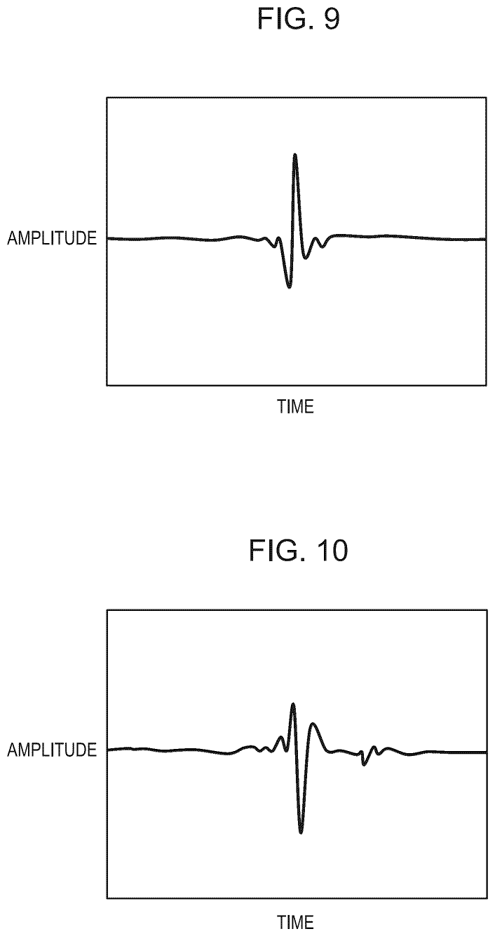

FIG. 8 is a diagram illustrating a histogram of the reference calculation data group according to the second exemplary embodiment. In FIG. 8, a horizontal axis represents a value of the calculation data (input and output error with respect to trained model 403), and a vertical axis represents a frequency. In addition, FIGS. 9 and 10 are diagrams illustrating a vibration waveform (time domain) generated when the first connector is correctly fitted, which are acquired by two different sensors in the second exemplary embodiment. FIG. 9 illustrates a vibration waveform acquired by the first sensor. FIG. 10 illustrates a vibration waveform acquired by the second sensor.

Trained model 403 extracts an element corresponding to the feature of the vibration waveform of the first connector at the time of normal fitting acquired by the first sensor from the input vibration waveform, and outputs, as the output data, the vibration waveform reconstructed based on the extracted feature. Thus, first reference calculation data group 541 calculated by trained model 403 by using, as the input, the vibration waveform of the first connector acquired by the first sensor also shows the statistical deviation to the small value in FIG. 8.

On the other hand, in second reference calculation data group 542 calculated by trained model 403 by using, as the input, the vibration waveform of the first connector acquired by the second sensor, since the connectors to be measured are the same and only the sensors are different, the statistical deviation is also shown to be slightly larger than first reference calculation data group 541 in FIG. 8.

Note that the input data used in a case where first reference calculation data 531 and second reference calculation data 532 are calculated is the vibration waveform of the first connector at the time of normal fitting. As described in the first exemplary embodiment, since the vibration waveform of the first connector at the time of normal fitting is the data having the statistical deviation, the statistical deviation also occurs in first reference calculation data group 541 and second reference calculation data group 542.

The reason why the statistical deviation occurs in the large value in second reference calculation data group 542 compared with first reference calculation data group 541 will be described below.

In the second exemplary embodiment, the input data used in a case where first reference calculation data 531 and second reference calculation data 532 are calculated is the vibration waveform acquired from the same target object called the first connector. Thus, in each input data, the feature due to the latch structure and the feature of the shapes or the like of the connectors described in the first exemplary embodiment are common. In addition, the input data used in a case where first reference calculation data 531 and second reference calculation data 532 are calculated is data acquired by two sensors having different shapes or the like, such as the first sensor and the second sensor. Thus, the vibration waveforms acquired by the first sensor and the second sensor have features depending on the shape and material characteristics of such sensors, and show different waveforms illustrated in FIGS. 9 and 10.

Here, second output data 522 is output by trained model 403 to extract a feature due to the shape or the like of the first sensor described above in addition to the feature due to the latch structure and the feature due to the shape or the like of the connector. Thus, a difference in feature due to the shapes or the like of the first sensor and the second sensor appears as a difference between the input data and the output data. As described above, second reference calculation data 532, which is the input and output error of trained model 403, reflects the difference in features due to the shape, material characteristics, or the like for each different sensor such as the first sensor and the second sensor, and second reference calculation data group 542 shows the statistical deviation illustrated in FIG. 8.

As described above, not only first reference calculation data group 541 but also second reference calculation data group 542 has a statistical deviation. Numerical interval data 550 is a numerical interval based on such statistical deviation of the reference group calculation data group, and as in the first exemplary embodiment, first numerical interval data 551 is calculated as an interval of the average value ±3σ of first reference calculation data group 541, and second numerical interval data 552 is calculated as an interval of the average value ±3σ of second reference calculation data group 542.

### [Operation Phase]

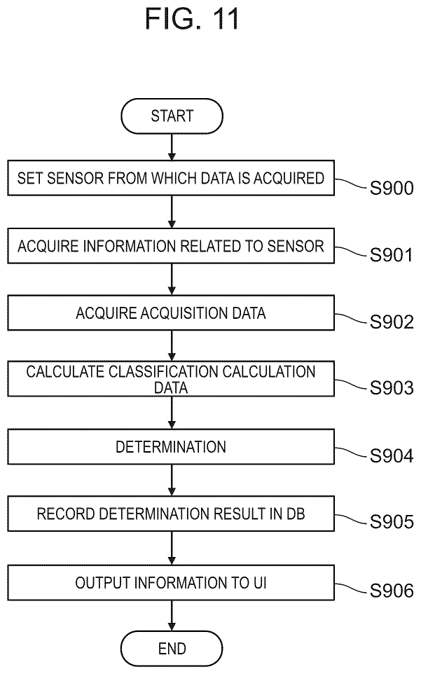

Hereinafter, operation phase S600 will be described with reference to FIGS. 2 and 11.

In operation phase S600 in FIG. 2, processor 202 calculates classification calculation data 630 for the acquisition data to be classified by using trained model 403 created in learning phase S400. Further, processor 202 performs determination processing (S904) to be described later on classification calculation data 630 by using numerical interval data 550 created in preparation phase S500, and outputs the information regarding the classification of acquisition data 610 based on the result.

FIG. 11 is a flowchart in operation phase S600 of the second exemplary embodiment. Hereinafter, a case where the fitting of the first connector is determined by using the second sensor will be described.

First, processor 202 sets a sensor to be used when data is acquired (S900). Here, in order to determine the fitting of the first connector acquired by the second sensor, the second sensor is set as the sensor. Note that the setting of the sensor used for the determination may be set in advance. In addition, the setting may be performed by the selection of the user using UI 300.

Subsequently, processor 202 acquires information related to the second sensor corresponding to the sensor set in step S900 from storage device 203 (S901). Specifically, processor 202 acquires at least second numerical interval data 552 as the information related to the second sensor.

Subsequently, the user performs the fitting work of the first connector by using the second sensor corresponding to the sensor set in step S900. Processor 202 acquires acquisition data 610 that is the vibration waveform of the first connector via the second sensor (S902).

Steps S903 to S906 are performed in a procedure similar to steps S803 to S806 in the first exemplary embodiment. However, in step S904, the second numerical interval data is based on the vibration waveform of the first connector at the time of normal fitting acquired by using the second sensor. Thus, in step S904, it is determined whether or not the first connector is correctly fitted by using second numerical interval data 552. In addition, in step S906, processor 202 outputs information indicating whether or not the fitting of the first connector is normally performed as the determination result of step S904. The determination result of step S904 is a result of classifying whether or not acquisition data 610 is data belonging to the second classification (vibration waveform of the first connector at the time of normal fitting acquired by the second sensor), and indicates the information regarding the classification of acquisition data 610.

As described above, classification device 200 can notify the user whether or not the fitting of the first connector is normally performed by using the vibration waveform acquired by using the second sensor.

In the related art, in a case where a sensor of a measurement device is replaced due to a failure or the like, the sensor may be changed to a sensor having a different shape, material characteristics, or the like in accordance with a production situation of the sensor. In this case, the user needs to create the trained model that has learned the vibration waveform at the time of fitting for each replaced sensor. However, in classification device 200 according to the second exemplary embodiment, the statistical deviation of the calculation data calculated from the vibration waveform of the connector at the time of fitting acquired by the sensor different from the predetermined sensor is recorded as the numerical interval data by using the trained model that has learned the vibration waveform of the connector at the time of fitting acquired by the predetermined sensor. As a result, even in a case where the sensor different from the predetermined sensor is used, it is possible to measure the vibration of the connector and determine the fitting without creating the trained model again. That is, the learning model that has learned the data belonging to the predetermined classification can be reused for classifying whether or not the data belongs to the classification different from the predetermined classification.

Note that, in the second exemplary embodiment, in a case where it is necessary to determine whether or not the fitting is normally performed by using the first sensor in addition to the second sensor as in a case where the replacement of the second sensor is partially performed, the first sensor may be set as a sensor that uses the first sensor instead of the second sensor in step S900. In addition, in a case where the first sensor is used, first numerical interval data 551 is used instead of second numerical interval data 552 in step S904. In addition, in a case where it is necessary to identify the first sensor and the second sensor, the first sensor and the second sensor may be set as the sensors to be used in step S900, and in step S904, it may be classified whether the acquisition data is acquired by the first sensor or the second sensor, or by neither of the sensors.

As described above, in the second exemplary embodiment, the operation of the classification system in a case where the acquisition data is classified into a different classification for each different sensor such as the first sensor and the second sensor has been described. As in the second exemplary embodiment, the numerical interval data is used, and thus, the trained model that has learned the data belonging to the predetermined classification such as the vibration waveform of the first connector at the time of fitting acquired by using the first sensor can be reused for the determination of the data belonging to the classification different from the predetermined classification such as the vibration waveform of the first connector at the time of fitting acquired by using the second sensor.

Note that, in the first exemplary embodiment, it has been described that the trained model that has learned the data acquired from the specific target object can be reused for the target object having the structure common to the specific target object as the source of the vibration. In addition, in the second exemplary embodiment, it has been described that the trained model that has learned the data acquired by using the specific sensor can be reused even in a case where the different sensor of the same type as the specific sensor is used.

In addition to these cases, in the present exemplary embodiment, the trained model that has learned the data acquired by using the specific sensor for the specific target object can also be reused in a case where the data is acquired by using the sensor different from the specific sensor for the target object different from the specific target object. In this case, at least the different target object is a target object having a structure common to the specific target object, and the different sensor may be a sensor of the same type as the specific sensor. In the reuse of the trained model, specifically, in the second exemplary embodiment, second reference calculation data group 542 is created by using the vibration waveform of the second connector at the time of normal fitting acquired by using the second sensor, instead of being created by using the vibration waveform of the first connector at the time of normal fitting acquired by using the second sensor. In second reference calculation data group 542 created in this manner, the statistical deviation reflecting the difference in the features due to the shapes or the like of the connectors of the vibration waveforms described in the first exemplary embodiment and the difference in the features due to the shapes and the like of the sensors of the vibration waveforms described in the second exemplary embodiment appears. Thus, it is possible to acquire the vibration waveform by the second sensor and determine the fitting of the second connector different from the first connector by using second numerical interval data 552 calculated from second reference calculation data group 542 and the learning model that has learned the data acquired by the first sensor as the vibration waveform of the first connector.

### Third Exemplary Embodiment

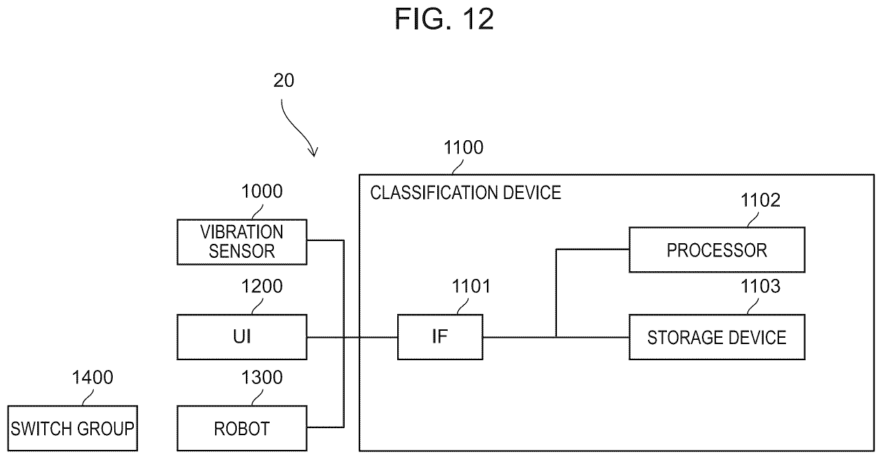

Hereinafter, a third exemplary embodiment will be described with reference to FIGS. 12 to 17. In a classification device, a classification system, and a classification method according to the third exemplary embodiment, target objects for which data is acquired is switched in various different forms such as a shape used for performing various types of control. In the third exemplary embodiment, a case where it is determined whether or not the switch is correctly operated in a case where the switch is operated by a robot will be described as an example. Note that description of details overlapping with the first exemplary embodiment will be omitted, and description will be given focusing on the difference.

### [Configuration of Classification System]

FIG. 12 is a block diagram illustrating an example of an overall configuration of classification system 20 including classification device 1100 according to the third exemplary embodiment. Classification device 1100 is a device having a switch operation function according to the present exemplary embodiment. Classification device 1100 is connected to robot 1300 and vibration sensor 1000 for operating switch group 1400.

Classification device 1100 controls an operation of robot 1300 according to a user operation, preset operation information, or the like to operate switch group 1400. Classification device 1100 includes IF 1101, processor 1102, storage device 1103, and UI 1200.

IF 1101 is an interface for connecting classification device 1100 to communicate with vibration sensor 1000 and robot 1300. In addition, IF 1101 transmits a control signal for controlling robot 1300 to robot 1300 and receives a signal from robot 1300 side.

Storage device 1103 is similar to storage device 203 in the first exemplary embodiment.

UI 1200 is similar to UI 300 in the first exemplary embodiment.

Vibration sensor 1000 is a sensor that detects vibration generated when robot 1300 operates switch group 1400 and acquires the vibration as vibration information. The vibration sensor is attached to a position where the vibration generated when robot 1300 operates switch group 1400 can be acquired. For example, the vibration sensor is a hand that actually operates a switch of robot 1300.

Robot 1300 is a robot disposed at a position where switch group 1400 can be operated. Robot 1300 is configured to control position coordinates of an operation portion with respect to a switch by a plurality of drive shafts, for example. The plurality of drive shafts are, for example, four shafts or six shafts. The operation portion for the switch is, for example, a hand of the robot. Note that robot 1300 is not limited to a specific shape, and may have any shape as long as the robot can operate switch group 1400.

Switch group 1400 includes one or a plurality of switches operated by robot 1300. There are various structures and shapes of switches. In the present exemplary embodiment, a toggle switch and a push switch will be described as examples of the switch.

### [Switch Operation Example: Toggle Switch]

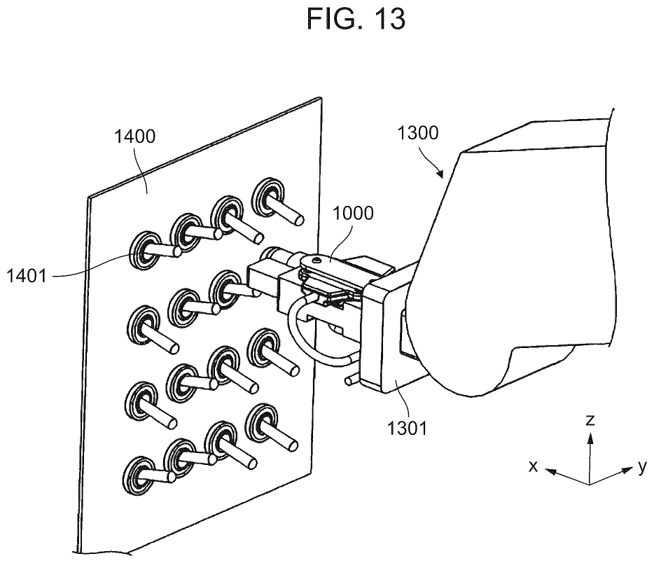

FIG. 13 is an outer appearance perspective view for explaining an operation example of the toggle switch by hand 1301 of robot 1300 according to the third exemplary embodiment. FIG. 13 illustrates a state where a plurality of toggle switches 1401 are provided as switch group 1400 on a wall surface. Toggle switch 1401 is configured to be vertically switchable. Processor 1102 instructs robot 1300 to move or rotate in up, down, left, and right directions. Hand 1301 approaches and comes into contact with target toggle switch 1401 in switch group 1400 in accordance with to an instruction content to robot 1300 to perform the operation.

### [Switch Operation Example: Push Switch]

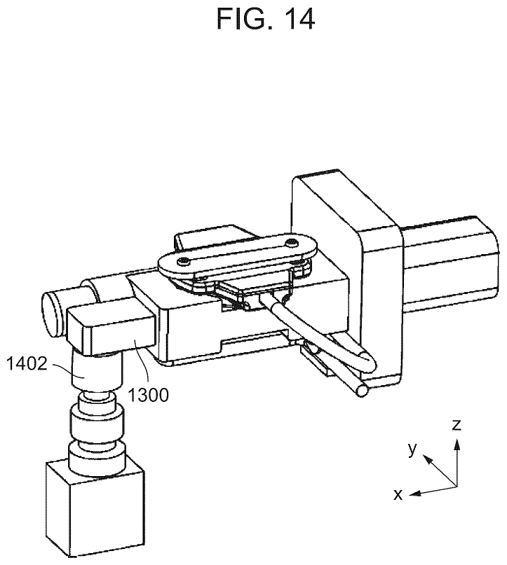

FIG. 14 is an outer appearance perspective view for explaining an operation example of the push switch by hand 1301 of robot 1300 according to the third exemplary embodiment. FIG. 14 illustrates push switch 1402 as a part of switch group 1400. Push switch 1402 can be operated by being pressed along a predetermined direction (in the present example, a z direction) in FIG. 14. As push switch 1402, there may be a push switch of which a position of an upper surface (in this example, a contact surface between push switch 1402 and hand 1301) does not change in accordance with an on or off state, but any switch may be used in the present exemplary embodiment. Processor 1102 instructs robot 1300 to move or rotate in up, down, left, and right directions. Hand 1301 approaches and comes into contact with target push switch 1402 in switch group 1400 in accordance with

### An Instruction Content to Robot 1300 to Perform the Operation.

### [Operation of Classification System]

Hereinafter, an operation of the classification system according to the third exemplary embodiment will be described. Classification system 20 according to the third exemplary embodiment processes the vibration waveform generated when toggle switch 1401 or push switch 1402 is operated by using the trained model that has learned the vibration waveform when toggle switch 1401 is correctly operated, and outputs a result of determining whether or not the switch is normally operated.

In the classification method according to the third exemplary embodiment, a difference from the classification method according to the first exemplary embodiment is that the vibration waveform generated when the switch is operated is used for learning data and test data, and the processing procedure is similar. Thus, the classification method according to the third exemplary embodiment will be described below with reference to FIG. 2.

In FIG. 2, in the case of the classification method according to the third exemplary embodiment, the trained model that has learned the vibration waveform generated when toggle switch 1401 is operated is calculated in “learning phase S400”, numerical interval data suitable for each switch is calculated by using the trained model created in learning phase S400 in “preparation phase S500”, and determination is performed on unknown data by using the trained model created in learning phase S400 and the numerical interval data created in preparation phase S500 in “operation phase S600”. Hereinafter, description of contents overlapping with the first exemplary embodiment will be omitted, and each phase will be described in detail focusing on a difference.

### [Learning Phase]

The processing performed in learning phase S400 according to the present exemplary embodiment is similar to the first exemplary embodiment, and learning is performed by using the plurality of pieces of learning data 401 belonging to the first classification to create trained model 403. In the present exemplary embodiment, the data belonging to the first classification is the vibration waveform (time domain waveform) generated when toggle switch 1401 is correctly operated by robot 1300. Thus, when any vibration waveform is input, trained model 403 created in learning phase S400 outputs, as the output data, the waveform obtained by bringing the input vibration waveform close to the vibration waveform generated when the first switch is correctly operated.

### [Preparation Phase]

The processing performed in preparation phase S500 according to the third exemplary embodiment is similar to the first exemplary embodiment, and numerical interval data 550 to be used in operation phase S600 to be described later is created from the test data by using trained model 403 created in learning phase S400. In the third exemplary embodiment, the test data includes first test data 511 and second test data 512. First test data 511 is a set of vibration waveforms (data belonging to the first classification) generated when toggle switch 1401 is correctly operated by robot 1300. Second test data 512 is a set of vibration waveforms (data belonging to the second classification) generated when push switch 1402 is correctly operated by robot 1300. In addition, numerical interval data 550 is first numerical interval data 551 created by first test data 511 and second numerical interval data 552 created by the second test data.

A method for calculating first numerical interval data 551 and second numerical interval data 552 is similar to the method in the first exemplary embodiment, and first numerical interval data 551 and second numerical interval data 552 are created in a creation procedure similar to steps S701 to S704, and thus, the details thereof are omitted.

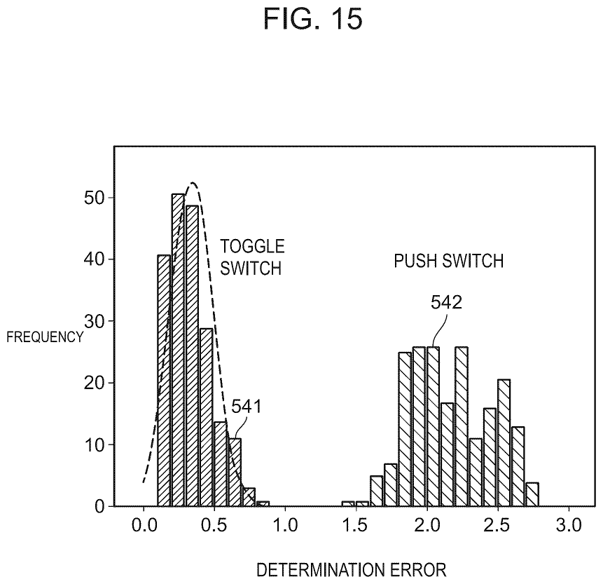

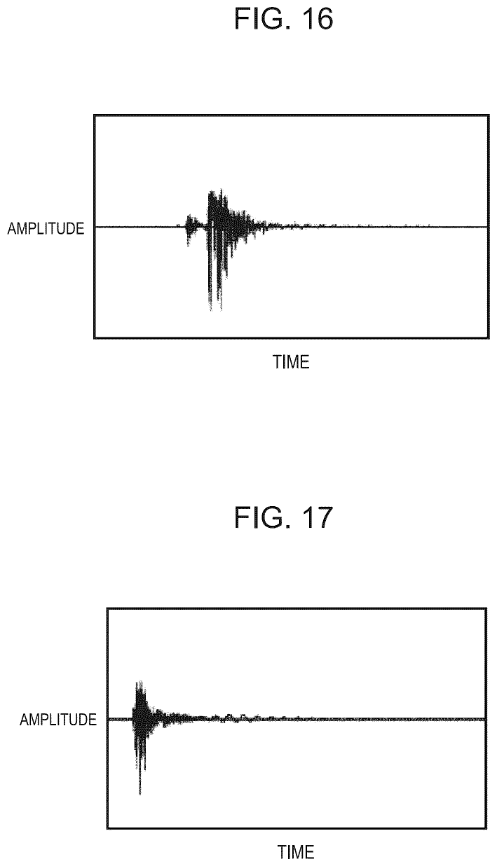

Hereinafter, a difference between first numerical interval data 551 and second numerical interval data 552 will be described with reference to FIGS. 15 and 16.

FIG. 15 is a diagram illustrating a histogram of the reference calculation data group according to the third exemplary embodiment. In FIG. 15, a horizontal axis represents a value of the calculation data (input and output error with respect to trained model 403), and a vertical axis represents a frequency. In addition, FIGS. 16 and 17 are diagrams illustrating vibration waveforms (time domain) generated when two types of switches according to the third exemplary embodiment are correctly operated. FIG. 16 illustrates the vibration waveform generated when toggle switch 1401 is correctly operated by robot 1300. FIG. 17 illustrates the vibration waveform generated when push switch 1402 is correctly operated by robot 1300.

Trained model 403 extracts an element corresponding to the feature of the vibration waveform generated when toggle switch 1401 is correctly operated by robot 1300 from the input vibration waveform, and outputs, as the output data, the vibration waveform reconstructed based on the extracted feature. Thus, first reference calculation data group 541 calculated by trained model 403 by using, as the input, the waveform generated when toggle switch 1401 is correctly operated shows the statistical deviation to the small value as illustrated in FIG. 15 of the third exemplary embodiment.

On the other hand, second reference calculation data group 542 calculated by trained model 403 by using, as the input, the vibration waveform generated when push switch 1402 is correctly operated by robot 1300 shows a statistical deviation to a value slightly larger than first reference calculation data group 541 as illustrated in FIG. 15.

Hereinafter, the reason why the statistical deviation occurs in the large value in second reference calculation data group 542 as compared with first reference calculation data group 541 in the third exemplary embodiment will be described.

First, the reason why the statistical deviation occurs in first reference calculation data group 541 and second reference calculation data group 542 will be described.

The toggle switch and the push switch internally have a common structure called a spring structure as the source of the vibration. When the switch is switched, since such a spring expands and contracts to switch the switch, the vibration waveform at the time of switch operation is caused by a single vibration of the spring structure inside the switch. Thus, the vibration waveform at the time of normal operation of the switch varies depending on the influence of the environment or the like for each operation, but is not significantly different and has a statistical deviation. Thus, as in the first exemplary embodiment, a statistical deviation also occurs in first reference calculation data group 541 and second reference calculation data group 542.

Next, the reason why the statistical deviation occurs in the large value in second reference calculation data group 542 compared to first reference calculation data group 541 will be described.

Like the vibration waveform of the connector described in the first exemplary embodiment, the vibration waveform of the switch is also influenced by different shapes or the like depending on the type of the switch. Thus, the vibration waveform at the time of switch operation has two features of a characteristic due to the shape of the switch in addition to the feature due to the vibration of the spring. For example, the vibration waveforms acquired from the toggle switch and the push switch show different vibration waveforms as illustrated in FIGS. 16 and 17 due to a difference in the shape or the like of the switch.

Here, second output data 522 is output to extract the feature due to the spring structure and the feature due to the shape or the like of toggle switch 1401 by trained model 403. Thus, a difference in features due to different shapes or the like depending on the types of switches between toggle switch 1401 and push switch 1402 is not extracted, and appears in a difference between the input data and the output data. Since such a difference in the features of the vibration waveforms due to the shapes of the switches is reflected in second reference calculation data 532 which is the input and output error of trained model 403, second reference calculation data group 542 is distributed at a position having a larger value than first reference calculation data group 541 as illustrated in FIG. 15.

Accordingly, as compared with first reference calculation data group 541, second reference calculation data group 542 shows the statistical deviation to the large value.

As described above, not only first reference calculation data group 541 but also second reference calculation data group 542 has a statistical deviation. Numerical interval data 550 is a numerical interval based on such a statistical deviation of the reference calculation data group, and as in the first exemplary embodiment, first numerical interval data 551 is calculated as an interval of the average value ±3σ of first reference calculation data group 541, and second numerical interval data 552 is calculated as an interval of the average value ±3σ of second reference calculation data group 542.

### [Operation Phase]

The processing performed in operation phase S600 according to the present exemplary embodiment is similar to the first exemplary embodiment, and processor 202 calculates classification calculation data 630 with respect to the acquisition data to be classified by using trained model 403 created in learning phase S400. Further, processor 202 performs the determination processing (S804) on classification calculation data 630 by using numerical interval data 550 created in preparation phase S500, and outputs the information regarding the classification of acquisition data 610 based on the result.

A processing flow of operation phase S600 in the third exemplary embodiment is similar to the first exemplary embodiment. In the operation phase of the third exemplary embodiment, classification device 1100 can operate in three patterns. A first pattern of the three patterns is a case where it is determined whether or not push switch 1402 is correctly operated by robot 1300. A second pattern is a case where it is determined whether or not toggle switch 1401 is correctly operated by robot 1300. A third pattern is a case where it is determined which switch is operated. First, an implementation procedure in a case where it is determined whether or not toggle switch 1401 is correctly operated by robot 1300, which is the first operation pattern, will be described.

Since the implementation procedure in a case where it is determined whether or not toggle switch 1401 is correctly operated by robot 1300 is similar to steps S800 to S806 described in the first exemplary embodiment, detailed description thereof will be omitted and description thereof will be given focusing on the difference.

In step S800, the target object to be determined is different. In the first operation pattern of the third exemplary embodiment, one push switch 1402 is selected from switch group 1400.

In step S801, processor 202 acquires at least second numerical interval data 552 as information related to push switch 1402. In addition, processor 202 acquires at least positional information for operating push switch 1402, as the information related to push switch 1402.

In step S802, a method for acquiring the vibration data is different. In the present exemplary embodiment, robot 1300 is operated to a predetermined position based on the information of push switch 1402 acquired in step S801, and push switch 1402 that is the target object is operated. Processor 1102 acquires acquisition data 610 that is the vibration waveform when push switch 1402 is correctly operated via vibration sensor 1000.

In step S804, the determination content is different. Processor 1102 determines whether or not push switch 1402 is correctly operated by using classification calculation data 630 calculated in step S803 and second numerical interval data 552 acquired in step S801. Note that, in a case where the operation of push switch 1402 is normally performed, since acquisition data 610 has a statistical deviation similarly to the case of the vibration waveform of push switch 1402 acquired when second numerical interval data 552 is calculated in preparation phase S500, it can be determined that the operation of the push switch is normal.

Accordingly, in operation phase S600, classification device 1100 can determine whether or not push switch 1402 is correctly operated by robot 1300 and can notify the user of the determination result.

As described above, it has been described that classification device 1100 can determine the operation of push switch 1402 by using trained model 403 that has learned the vibration waveform during the normal operation of toggle switch 1401 in the first operation pattern. In the related art, in order to detect that the switch is normally operated and the operated switch is switched, it is necessary for the user to create the trained model that has learned the vibration waveform when the switch is correctly operated for each switch having a different shape or the like. However, in the trained model that has learned the vibration waveform of the predetermined switch as in classification device 1100, the statistical deviation of the calculation data calculated from the vibration waveform of the switch different from the predetermined switch is recorded as the numerical interval data, and thus, the vibration waveform of the switch different from the predetermined switch can be processed without creating the trained model again. As a result, it can be determined whether the switch is correctly operated. That is, the learning model that has learned the data belonging to the predetermined classification can be reused for determining whether or not the data belongs to the classification different from the predetermined classification.

Next, a case where classification device 1100 determines whether or not toggle switch 1401 is correctly operated by robot 1300, which is the second operation pattern, will be described. Since the second operation pattern is performed in a procedure similar to steps S800 to S806 of the first operation pattern in the third exemplary embodiment, although not described in detail, toggle switch 1401 is set as the target object instead of push switch 1402 in step S800, and first numerical interval data 551 is used instead of second numerical interval data 552 in step S804.

Finally, a case where it is determined which switch is operated in the vibration waveform acquired by classification device 1100, which is the third operation pattern of the third exemplary embodiment, will be described. Since the third operation pattern of the third exemplary embodiment is performed in a procedure similar to steps S800 to S806 of the first operation pattern of the third exemplary embodiment, the overlapping content is omitted, and the description will be given focusing on the difference.

In S800, it is not known which switch is operated. Thus, processor 1102 sets in advance a candidate for the switch to be operated as the target object to be determined. In the third exemplary embodiment, toggle switch 1401 and push switch 1402 are set as the target objects to be determined.

In step S801, the acquired information is different. Processor 1102 acquires numerical interval data, which is information related to the candidate for the switch set in step S800 in advance. Specifically, in the third exemplary embodiment, first numerical interval data 551 that is information related to toggle switch 1401 and second numerical interval data 552 that is the information related to push switch 1402 are acquired.

In step S804, the determination content is different. Processor 1102 determines which switch is correctly operated by using classification calculation data 630 calculated in step S803, first numerical interval data 551 and second numerical interval data 552 acquired in step S801, and acquisition data 610. Specifically, it is determined whether the value of classification calculation data 630 is included in the numerical interval indicated by first numerical interval data 551 or the numerical interval indicated by second numerical interval data 552. For example, processor 1102 determines that toggle switch 1401 is correctly operated in a case where classification calculation data 630 is included in first numerical interval data 551, and determines that there is no corresponding switch in a case where classification calculation data 630 is not included in any numerical interval.

In step S806, the information regarding the classification of acquisition data 610 output to UI 1200 is different. Specifically, processor 1102 outputs information indicating which switch is correctly operated as the determination result of step S804. In addition, when acquisition data 610 is classified as not the vibration waveform when any switch is correctly operated, processor 1102 outputs information indicating that it is determined that there is no corresponding switch. As described above, processor 1102 outputs information indicating that the acquisition data is classified as the vibration waveform when the switch is correctly operated.

Accordingly, in operation phase S600, classification device 1100 can notify the user of which switch the robot is operated.

As described above, in the third operation pattern, classification device 1100 can identify which switch among the plurality of switches is operated by using trained model 403 that has learned the vibration waveform of toggle switch 1401 at the time of normal operation, in the related art, in order to identify operations on the plurality of switches such as toggle switch 1401 and push switch 1402, it is necessary for the user to create the trained model that has learned the vibration at the time of operation for each switch.

However, in the trained model that has learned the vibration waveform of the predetermined switch at the time of operation as in classification device 1100, the statistical deviation of the reference calculation data calculated from the vibration waveform of the switch different from the predetermined switch at the time of operation is recorded as the numerical interval data, and thus, it is possible to identify which switch is operated by using the trained model that has learned the vibration waveform of the predetermined switch at the time of operation. That is, the learning model that has learned the data belonging to the predetermined classification can be reused for identifying the plurality of classifications.

Note that, in the third exemplary embodiment, examples of the switch include a toggle switch and a push switch, but other types of switches such as a rocker switch may be applied to, as the target object, the present invention. In addition, the switch is not limited to a switch that performs electrical switching, and may be a switch that performs mechanical switching, such as a lever.

In addition, the third exemplary embodiment has exemplified the configuration in which the operation result of the switch is determined based on the vibration when the switch is operated by robot 1300. The present invention is not limited to this configuration, and the switch may be operated by a person. In this case, for example, a vibration sensor may be installed around the switch, a vibration signal generated when a person operates the switch may be acquired, and the type of the switch operated and the operation result may be determined based on the vibration signal. In addition, a simple switch switching may be determined as an operation instead of an operation by a person or a robot.

### Other Exemplary Embodiments

As described above, the above exemplary embodiments have been described as examples of the techniques disclosed in the present application. The techniques according to the present disclosure are, however, not limited to the above exemplary embodiments, and are also applicable to other exemplary embodiments with an appropriate modification, replacement, addition, omission, or the like made thereto. Thus, other exemplary embodiments will be exemplified below.

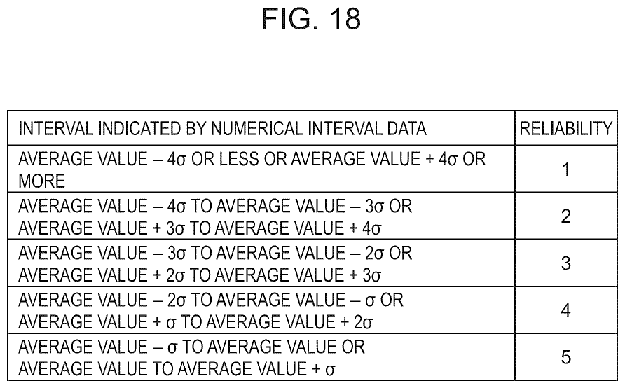

In the operation phase of the above exemplary embodiments, the processor is configured to output the result of the classification as to whether or not the acquisition data belongs to the predetermined classification as the information regarding the classification of the acquisition data, but the acquisition data may be classified by outputting reliability as to whether or not the acquisition data belongs to the predetermined classification. Hereinafter, the calculation of the reliability will be described with reference to FIG. 18. FIG. 18 is a table representing a relationship between the interval indicated by the numerical interval data corresponding to each classification and the reliability. An average value and standard deviation a in FIG. 18 are the average value and the standard deviation a of the reference calculation data group used for the calculation of the numerical interval data. Here, the calculation data calculated from the data belonging to the predetermined classification has a high frequently indicating a value close to the average value. Thus, it is determined that the closer the value of the classification calculation data calculated from the acquisition data is to the average value, the higher the reliability of whether the classification belongs to the predetermined classification. For example, in a case where the classification calculation data calculated from the acquisition data indicates a value of the average value+2.5σ in the numerical interval data, the reliability is determined to be 3 on the assumption that the classification calculation data is positioned in an interval of the average value+2σ or more and less than the average value+3σ (more specifically, an interval of the average value −3σ to the average value −2σ or the average value+2a to the average value+3σ). In addition, in a case where the classification calculation data calculated from the acquisition data indicates a value of the average value+5σ in the numerical interval data, the classification calculation data is positioned in an interval of the average value+4σ or more (more specifically, an interval of the average value −4σ or less or the average value+4σ or more). In this case, since a frequency at which the value of the calculation data calculated from the data belonging to the predetermined classification is positioned in this interval is low, the reliability is determined to be 1. Note that the interval indicated by the numerical interval data is not limited to this example, and different values may be used. In addition, an output of the reliability is not limited to five-stage evaluation, and any stage may be provided. In addition, the reliability is not output as a numerical value, and may be a sentence or the like, and is not limited thereto as long as the reliability is information indicating reliability as to whether the information belongs to the predetermined classification.

In the above exemplary embodiments, although it has been described that the vibration waveform of the connector at the time of fitting and the vibration waveform of the switch at the time of operation are used as the data belonging to the first classification, the data belonging to the second classification, and the data used for the acquisition data, the present invention is not limited thereto as long as the data has the statistical deviation.

In addition, in the above exemplary embodiments, although it has been described that the vibration waveform of the connector at the time of fitting and the vibration waveform of the switch at the time of operation are used as the data having the statistical deviation, the present invention is not limited thereto as long as the data is acquired from the target object having the common element by using the same type of sensor. For example, in the above exemplary embodiments, although it has been described that the data related to the latch structure in the connector and the spring structure in the switch is the data having the statistical deviation in a case where the vibration sensor is used, the data may be data related to the structure included in the target object such as a door opening and closing mechanism and a lock mechanism. Here, the output data output by the trained model using, as the input, the data acquired from the target object having the common element by using the same type of sensor is obtained by extracting and reconstructing the feature due to the element or the like common to the target object, and has the statistical deviation. As a result, the statistical deviation occurs in the reference calculation data group calculated by using the trained model from the data acquired by using the same type of sensor from the target object having the common element. As such, the processor may classify the acquisition data.

In addition, in the above exemplary embodiments, although it has been described that the vibration sensor is used as the sensor that acquires the data having the statistical deviation, the sensor is not limited to a pressure sensor, an image sensor, an acceleration sensor, a temperature sensor, and the like.

For example, in a case where a road sign is classified by using an image sensor, classification is performed by extracting, as features, a shape and a color arrangement, which are common elements in outer appearance of the road sign. Specifically, in a classification system that classifies a sign prohibiting entry of a vehicle and a sign prohibiting passage of a vehicle, in a case where a trained model that has learned an image of the sign prohibiting the entry of the vehicle is used, numerical interval data is create for each of the image of the sign prohibiting the entry of the vehicle and an image of the sign prohibiting the passage of the vehicle by using the trained model. It is possible to reuse the trained model that has learned the image of the sign prohibiting the entry of the vehicle by using the numerical interval data created in this manner, and to classify whether a sign of a target image is the sign prohibiting the entry of the vehicle, the sign prohibiting the passage of the vehicle, or neither of these signs. As a result, since it is not necessary to create the trained model for each sign, it is possible to reduce the number of data and the amount of calculation required for constructing a classification system for identifying a sign.

In addition, in the above exemplary embodiments, although it has been described that the target object is an inanimate object such as the connector or the switch, the target object may be a living object, and biological data may be used as the data having the statistical deviation in the classification system.

In addition, in the above exemplary embodiments, although it has been described that the vibration waveform in the time domain is used, the present invention is not limited thereto. For example, data obtained by processing the vibration waveform in the time domain, such as data obtained by performing frequency analysis, may be used as the learning data.

In addition, in the above exemplary embodiments, although it has been described that two pieces of numerical interval data are stored in the storage device, the number of pieces of numerical interval data may be one or three or more, and is not limited. That is, the number of classifications of the target object is not limited.

In addition, in the above exemplary embodiments, although it has been described that the method of the auto encoder is used as a learning method, a more specific algorithm of the auto encoder is not particularly limited. For example, a known method such as a convolutional neural network (CNN) may be used, or another unsupervised learning method or algorithm may be used.

In addition, a system in which a trained model is created by using a label prediction (classification) method generally known as supervised learning and which switch among a toggle switch, a push switch, and a rocker switch is correctly pressed will be described as an example of another learning method.

Here, the vibration waveform generated when the toggle switch is correctly operated, the vibration waveform when the push switch is correctly operated, and a label indicating which of the toggle switch and the push switch the vibration waveform is when is operated are used as the learning data. The machine learning model is trained to extract the feature of the input vibration waveform and associate a classification calculated from the extracted feature with a label. The trained model generated by performing such training can classify whether the input vibration waveform is the vibration waveform generated when the toggle switch is correctly operated or the vibration waveform generated when the push switch is correctly operated. That is, it is possible to determine which one of the toggle switch and the push switch is operated by using the trained model.

Here, the trained model outputs an inference result (indicating which switch is operated) as a probability. For example, the inference result is output as a probability oo % that the toggle switch is correctly operated and a probability oo % that the push switch is correctly operated. An output in a case where the vibration waveform in which the toggle switch is correctly operated is input to the trained model that is sufficiently trained is an output having a probability 99% that is the vibration waveform in which the toggle switch is correctly operated and a probability 1% that is the vibration waveform in which the push switch is correctly operated, and the input vibration waveform can be classified as the input vibration of the toggle switch. Similarly, in a case where the vibration waveform generated when the push switch is correctly operated is input, the input vibration waveform can also be classified as the vibration waveform of the push switch.

Here, in a case where the rocker switch having the spring structure common to the toggle switch and the push switch is input to the trained model, the output has the statistical deviation such that, for example, a probability that the toggle switch is correctly operated is 60% and a probability that the push switch is correctly operated is 40%. Thus, in a case where the trained model created by using the supervised learning is reused, the output data from such a trained model is used as the reference calculation data, and the numerical interval data is created by using the plurality of pieces of reference calculation data. The numerical interval data indicates a numerical interval corresponding to the number of labels at the time of training of the trained model, and in this case, indicates a numerical interval due to two values of the probability that the toggle switch is correctly operated and the probability that the push switch is correctly operated.

In addition, the output data when the rocket switch is input to the trained model is also calculated from the acquisition data to be classified, and a switch to which the acquisition data corresponds is classified according to whether or not the classification calculation data is included in the numerical interval indicated by the numerical interval data.

The numerical interval data created in this manner is used, and thus, it is possible to reuse the trained model using the vibration waveforms in which the toggle switch and the push switch are correctly operated for the classification of whether the operation target is the rocker switch, the toggle switch, the push switch, or neither of these switches. That is, the trained model that has learned the data belonging to the predetermined classification by using the supervised learning can also be reused for a case where the data belonging to the classification different from the predetermined classification is classified.

In addition, in the above exemplary embodiments, although it has been described that the learning phase and the preparation phase are performed by the classification device, the learning phase and the preparation phase may be performed by an external device different from the classification device, and the operation phase may be performed by transferring the trained model and the numerical interval data to the storage device of the classification device. In addition, the classification device may be a server provided on a cloud network, and the classification system including the vibration sensor may be connected by a network.

The present disclosure can be applied to a classification device that determines whether or not input data belongs to a predetermined classification.

What is claimed is:

1. A classification method comprising:
calculating a plurality of pieces of reference calculation data from a plurality of pieces of data belonging to a second classification by using a machine learning model that has learned learning data including a plurality of pieces of data belonging to a first classification;
calculating classification calculation data from one piece of acquisition data by using the machine learning model; and
comparing data based on the plurality of pieces of reference calculation data with the classification calculation data to classify whether or not the one piece of acquisition data belongs to the second classification,
wherein the plurality of pieces of data belonging to the first classification, the plurality of pieces of data belonging to the second classification, and the one piece of acquisition data are pieces of data having a statistical deviation, and
the second classification is a classification different from a classification to which the plurality of pieces of data included in the learning data belong.

2. The classification method according to claim 1, wherein the data having the statistical deviation is data acquired by a same type of sensor, the data being data acquired from a target object having a common element.

3. The classification method according to claim 2, wherein the common element is a structure of the target object.

4. The classification method according to claim 3, wherein the structure is a latch structure.

5. The classification method according to claim 3, wherein the structure is a spring structure.

6. The classification method according to claim 2, wherein the first classification and the second classification are classifications based on types of the target object.

7. The classification method according to claim 2, wherein the first classification and the second classification are classified for different sensors.

8. The classification method according to claim 2, wherein the target object is a connector.

9. The classification method according to claim 2, wherein the target object is a switch.

10. The classification method according to claim 2, wherein the sensor is a vibration sensor.

11. The classification method according to claim 2, wherein the sensor is an image sensor.

12. The classification method according to claim 2, wherein the plurality of pieces of data belonging to the first classification and the plurality of pieces of data belonging to the second classification are pieces of data in a case where a predetermined operation of the target object is normally performed.

13. The classification method according to claim 1, wherein the machine learning model is trained by using an autoencoder.

14. The classification method according to claim 13, wherein
the plurality of pieces of reference calculation data are a plurality of pieces of data based on the plurality of pieces of data belonging to the second classification and a plurality of pieces of output data in a case where the plurality of pieces of data belonging to the second classification are input to the machine learning model, and
the classification calculation data is one piece of data based on the one piece of acquisition data and one piece of output data in a case where the one piece of acquisition data is input to the machine learning model.

15. The classification method according to claim 1, wherein the machine learning model is trained by using supervised learning.

16. The classification method according to claim 15, wherein
the plurality of pieces of reference calculation data are a plurality of pieces of output data in a case where the plurality of pieces of data belonging to the second classification are input to the machine learning model, and
the classification calculation data is one piece of output data in a case where the one piece of acquisition data is input to the machine learning model.

17. A classification device comprising:
a processor; and
a storage device having an instruction executable by the processor;
wherein the instruction is configured to
calculate a plurality of pieces of reference calculation data from a plurality of pieces of data belonging to a second classification by using a machine learning model that has learned learning data including a plurality of pieces of data belonging to a first classification,
calculate classification calculation data from one piece of acquisition data by using the machine learning model, and
compare data based on the plurality of pieces of reference calculation data with the classification calculation data to classify whether or not the one piece of acquisition data belongs to the second classification,
the plurality of pieces of data belonging to the first classification, the plurality of pieces of data belonging to the second classification, and the one piece of acquisition data are pieces of data having a statistical deviation, and
the second classification is a classification different from a classification to which the plurality of pieces of data included in the learning data belong.

18. A classification system comprising:
a sensor that acquires one piece of acquisition data;
a classification device; and
a notification device that notifies a user of a classification result of the classification device,
wherein the classification device is configured to
calculate a plurality of pieces of reference calculation data from a plurality of pieces of data belonging to a second classification by using a machine learning model that has learned learning data including a plurality of pieces of data belonging to a first classification,
calculate classification calculation data from one piece of acquisition data acquired by the sensor by using the machine learning model, and
compare data based on the plurality of pieces of reference calculation data with the classification calculation data to output a result of classifying whether or not the one piece of acquisition data belongs to the second classification to the notification device,
the plurality of pieces of data belonging to the first classification, the plurality of pieces of data belonging to the second classification, and the one piece of acquisition data are pieces of data having a statistical deviation, and
the second classification is a classification different from a classification to which the plurality of pieces of data included in the learning data belong.
